(19) United States
(12) Patent Application Publication
(10) Pub. No.: US 2026/0178651 A1
(43) Pub. Date: Jun. 25, 2026

(54) METHOD AND APPARATUS FOR DATA GENERATION

(71) Applicant: Samsung Electronics Co., Ltd., Suwon-si (KR)

(72) Inventors: Hyunjeong LEE, Suwon-si (KR); Minki JEONG, Suwon-si (KR); Seungin PARK, Suwon-si (KR); Dongwook LEE, Suwon-si (KR); Sangil JUNG, Suwon-si (KR)

(73) Assignee: Samsung Electronics Co., Ltd., Suwon-si (KR)

(21) Appl. No.: 19/340,718

(22) Filed: Sep. 25, 2025

(30) Foreign Application Priority Data
Dec. 19, 2024 (KR) 10-2024-0191626

(51) Int. Cl. G06F 16/358; G06F 16/3329; G06N 3/0475

(52) U.S. Cl. CPC G06F 16/358; G06F 16/33295; G06N 3/0475

(57) ABSTRACT

A method and apparatus with data generation are provided. A method of generating visual question answering (VQA) data includes generating thumbnail data corresponding to content data, obtaining a question answering (QA) set generated based on text data extracted from the content data, and generating VQA data including a pair comprising the thumbnail data and the QA set.

### CROSS-REFERENCE TO RELATED APPLICATIONS

This application claims the benefit under 35 USC § 119(a) of Korean Patent Application No. 10-2024-0191626, filed on Dec. 19, 2024, in the Korean Intellectual Property Office, the entire disclosure of which is incorporated herein by reference for all purposes.

### BACKGROUND

### 1. Field

The following description relates to a method and apparatus with data generation, and more particularly, a method and apparatus with visual question answering (VQA) data generation.

### 2. Description of Related Art

A visual question answering (VQA) system is artificial intelligence technology that integrates computer vision and natural language processing (NLP) to interpret visual content and generate contextually relevant answers to textual queries about images. A VQA system may be used in various application fields, such as image caption generation, content-based image retrieval, and medical diagnosis assistance. A VQA system may typically employ a multi-modal training methodology to combine image data with text data. Such a system may combine two core components: (i) a convolutional neural network (CNN), which extracts features from an image, and (ii) a transformer-based model, which processes a natural language question and identifying relevance between the image and the question, to understand and answer a question about an image like humans.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects provide technology for generating a question answering (QA) set regarding visual QA (VQA) from data including an image and a text and storing the generated QA set as a pair with a thumbnail of the data.

However, technical aspects are not limited to the foregoing aspects, and there may be other technical aspects.

In one general aspect, a processor-implemented method includes generating thumbnail data corresponding to content data; obtaining a question answering (QA) set generated based on text data extracted from the content data; and generating visual question answering (VQA) data comprising a pair of the thumbnail data and the QA set.

The method may further include training a first generative model using the VQA data.

The obtaining of the QA set may include separating the content data into image-type data and text-type data; and obtaining a QA set generated based on the text-type data.

The obtaining of the QA set may include separating the content data into image-type data and text-type data; and applying the text-type data to a second generative model to generate the QA set.

The applying of the text-type data to the second generative model may include generating a prompt based on the text-type data; and obtaining the QA set generated in response to the prompt from the second generative model.

The content data may include document data including at least one piece of image data and associated text data.

The content data may include image data and associated description data.

The generating of the thumbnail data may include dividing the content data into a plurality of sections; and generating thumbnail data for each section of the content data.

The obtaining of the QA set may include extracting text data from each section; and obtaining a QA set for each section based on the extracted text data.

The generating of the VQA data may include generating one piece of VQA data for each section, the one piece of VOA data including a pair of thumbnail data and the QA set corresponding to that each section.

The generating of the thumbnail data may include arranging image data and corresponding text data in a predetermined template.

In one general aspect, provided is a non-transitory computer-readable storage medium, storing a computer program that operates in combination with hardware, configured to generate thumbnail data corresponding to content data, obtain a question answering (QA) set generated based on text data extracted from the content data, and generate visual QA (VQA) data comprising a pair of the thumbnail data and the QA set.

In one general aspect, an electronic device includes one or more processors; and a memory storing instructions, wherein the instructions, when executed by the one or more processors, configure the one or more processors to generate thumbnail data corresponding to content data, obtain a question answering (QA) set generated based on text data extracted from the content data, and generate visual QA (VQA) data comprising a pair of the thumbnail data and the QA set.

The one or more processors may be further configured to train a first generative model using the VQA data.

The one or more processors may be further configured to separate the content data into image-type data and text-type data; and obtain the QA set generated based on the text-type data.

The one or more processors may be further configured to separate the content data into image-type data and text-type data; and apply the text-type data to a second generative model to generate the QA set.

The one or more processors may be further configured to generate a prompt based on the text-type data; and obtain the QA set generated in response to the prompt from the second generative model.

The one or more processors may be further configured to divide the content data into a plurality of sections; and generate thumbnail data for each section of the content data.

Other features and aspects will be apparent from the following detailed description, the drawings, and the claims.

### BRIEF DESCRIPTION OF THE DRAWINGS

FIG. 1 is an example operation flowchart illustrating a method of generating a visual question answering (VQA) data according to one or more embodiments.

FIGS. 2A through 2C are diagrams each illustrating thumbnail data according to one or more embodiments.

FIG. 3 is a diagram illustrating an example method of generating VQA data based on document data according to one or more embodiments.

FIG. 4 is a diagram illustrating an example method of generating VQA data based on a pair of image data and description data according to one or more embodiments.

FIG. 5 is a diagram illustrating an example operation of generating a QA set based on a second generative model according to one or more embodiments.

FIG. 6 is a diagram illustrating an example method of generating VQA data for each section of content data according to one or more embodiments.

FIG. 7 is a diagram illustrating an example configuration of an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

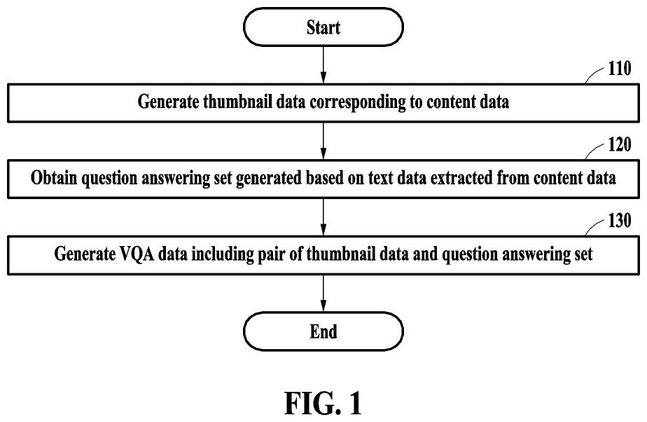

FIG. 1 is an operation flowchart illustrating an example method of generating visual question answering (VQA) data according to one or more embodiments.

The VQA data may include an image and one or more pieces of question answering (QA) data related to the image. The QA data may include a question and an answer to the question.

In one or more embodiments, the method of generating VQA data may be performed by an electronic device including one or more processors. A detailed hardware configuration of the electronic device that performs the method is described below.

The method may include operation 110, which is performed to generate thumbnail data corresponding to content data.

The content data refers to digital data including information and may include various types of data, such as image-type data and text-type data.

For example, the content data may include document data including at least one piece of image data and associated text data. As a non-limiting example, the document data may include an electronic document and/or a webpage in various formats (e.g., PDF, DOC, TXT) Examples of the document data may include posts, reports, papers, and/or manuals.

For example, the content data may include image data and description data associated with the image data. The image data and the description data may be a pair. The description data, which is text-type data describing an image, may include caption data of the image as a non-limiting example. The description data may be obtained based on a search result of the image data. For example, the description data may include text data extracted from a document including the image data, where the extracted text data is determined to be a relevant description to the image data.

The thumbnail data may be image-type data representing the content data and may include: any one or any combination of any two or more of: for example, (i) data converting content data into an image, (ii) image data obtained by capturing a screen displaying the content data, and (iii) data obtained that reconstructs data included in the content data and convert the data into an image.

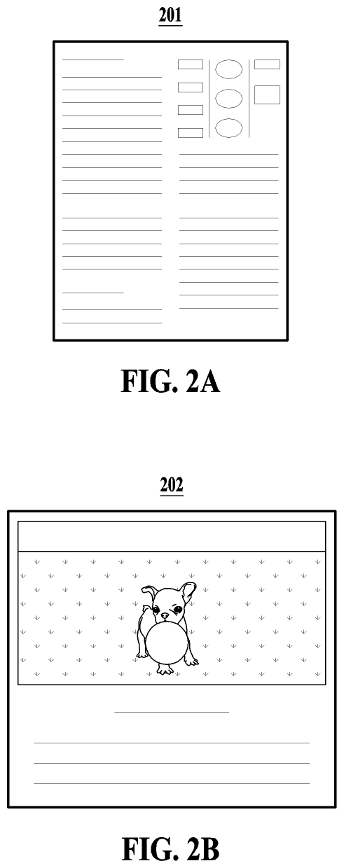

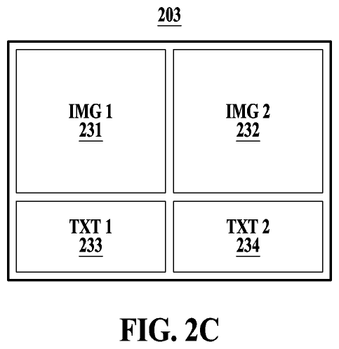

For example, referring to FIG. 2A, thumbnail data 201 corresponding to document data may include data that converts a page of the document data into an image. For document data of a file with multiple pages, thumbnail data may include at least one of a preview image of a page of the file and an image that juxtaposes the multiple pages of the file.

For example, referring to FIG. 2B, thumbnail data 202 of content data including image data and description data of the image data may include data that juxtaposes the image data and the description data and converts the juxtaposed image data and description data into an image.

Referring again to FIG. 1, according to one or more embodiments, operation 110 may include generating the thumbnail data by arranging image data included in the content data and text data corresponding to the image data in a predetermined template. The text data may include description data, caption data, and/or a text associated with an image included in document data.

For example, referring to FIG. 2C, a template 203 of thumbnail data may include regions 231 and 232 designated for arranging image data, and regions 233 and 234 designated for arranging text data. One or more pieces of image data and corresponding description data may be arranged/organized in the template 203 of thumbnail data to generate image-type thumbnail data.

Additionally, operation 110 may include separating the content data into a plurality of sections and generating a thumbnail for each section of the content data. A section may represent a logical division, such as a page unit, a table-of-contents unit, or an image unit of the content data. For example, a specific image included in the content data and a corresponding part determined to be the description of the image may be determined as one section. Further details regarding section-based thumbnail generation are described below.

The method of generating VQA data may further include operation 120, which is performed to obtain a QA set generated based on text data extracted from the content data.

The QA set may comprise one or more pieces of QA data. The QA data may include a question and an answer to the question. The question may be a question derived from the content data and may include, for example, a question about information included in the content data, a question based on the information included in the content data, and/or a question derived from the information included in the content data. The answer may be data indicating a correct answer to a question. The answer may comprise text data, including one or more words or one or more sentences.

The QA data may include various types, such as subjective type (short-answer or essay type) or multiple-choice type. The multiple-choice-type QA data may include a list of options, and the answer may identify one or more correct choices among the options. If options are included, the question may be a multiple-choice-type question. If options are included, the answer to the question may be data indicating one or more items corresponding to a correct answer among items included in the options.

According to one or more embodiments, operation 120 may include separating the content data into image-type data and text-type data, and obtaining a QA set generated based on the text-type data. The QA set may be generated based on text data extracted from the content data. The QA set may be generated based on content and context information indicated by the text data. By using the text-type data extracted from the content data, the QA set that reflects the subject matter of the content data may be generated. For example, when the text data includes a description of an image, QA data related to the image may be generated.

According to one or more embodiments, operation 120 may include separating the content data into image-type data and text-type data, and obtaining a QA set by applying the text-type data to a generative model. The QA set may be generated in the generative model. The generative model may refer to a neural network configured to generate new data (e.g., text, image, audio, and/or video) based on input data (e.g., a user utterance or a text input). Examples of the generative model may include, but are not limited to, a large language model (LLM), a large multimodal model (LMM), a foundation model (FM), and a multi-modal foundation model (MMFM).

According to one or more embodiments, the obtaining of the QA set by applying the text-type data to the generative model may include generating a prompt based on the text-type data, submitting the prompt to the generative model, and obtaining the QA set generated corresponding to the prompt from the generative model.

The prompt may include data requesting to generate a question related to the text-type data and an answer to the question. The prompt may include text data extracted from the content data. For example, the prompt may include data requesting to generate a question from input text data and an answer to the question. Non-limiting examples of such a question may include a short-answer question, an essay-type question, or a multiple-choice question, including the correct answer and optional distractors.

Operation 120 may include obtaining a QA set for each section of the content data, based on text data extracted from each section. The obtaining of a QA set by each section of the content data is described in detail below.

The method of generating VQA data may include operation 130, which is performed to generate VQA data including a pair of thumbnail data and a corresponding QA set. The thumbnail data generated in operation 110 and the QA set obtained in operation 120 may be determined to be a pair. The VQA data may refer to a pair of thumbnail data and a QA set.

According to one or more embodiments, operation 130 of generating the VQA data may include generating VQA data including a pair of thumbnail data and the QA set for each section of the content data. Each VQA data may include a pair of thumbnail data of a specific section in the content data and a QA set of the section. Multiple pieces of VQA data corresponding to a single piece of content data may be generated from a plurality of sections of the single piece of content data. The generating of VQA data for each section of the content data is described in detail below.

The thumbnail data included in the VQA data may include data to indicate or identify content data from which a QA set is generated. The VQA data, by including thumbnail data forming a pair with a QA set, may preserve information on content data from which the QA set is generated. The data size of VQA data including thumbnail data may be significantly smaller than the data size of VQA data including the whole content data.

The method of generating VQA data may include training a generative model based on the VQA data. As described above, the generative model may refer to a neural network that generates new data (e.g., text, image, audio, and/or video) based on a user input (e.g., a user utterance or a text input). For clarity, the generative model trained using VQA data may be referred to as a “first generative model,” and the generative model used to generate a QA set may be referred to as a “second generative model.”

The VQA data may be used to train or fine-tune the first generative model. For example, based on the VQA data, the first generative model may be trained or fine-tuned to generate a QA set for a new piece of content data, to generate an answer corresponding to question data and the content data, or to generate an analysis result related to image and/or text data included in the content data.

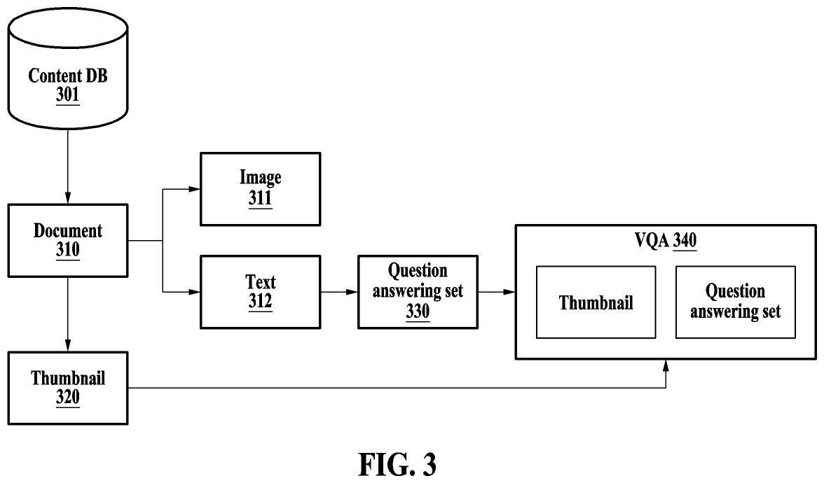

FIG. 3 is a diagram illustrating an example method of generating VQA data based on document data according to one or more embodiments.

As described above, content data may include document data 310 including at least one piece of image data and text data. The document data 310 may be obtained from a content database 301.

The content database 301 may store content data including the document data 310. The content database 301 may store content data collected through web crawling and/or content data registered by a user. The content database 301 may include image data and description data of the image data in addition to the document data 310.

Thumbnail data 320 corresponding to the document data 310 may be generated. For example, the thumbnail data 320 may include one or more of: (i) image data converted from a portion (e.g., a page) of the document data 310, (ii) image data captured from a display outputting at least a portion of the document data 310, and (iii) reconstructed data derived from the document data 310 and converted into an image.

Text data 312 may be separated from image data 311 and extracted from the document data 310. Based on the extracted text data 312, a QA set 330 corresponding to the document data 310 may be obtained.

A pair comprising the thumbnail data 320 and the QA set 330 may be generated as VQA data 340 corresponding to the document data 310. The thumbnail data 320 may include data that indicates or identifies the document data 310 where the QA set 330 is generated. The VQA data 340, by including the thumbnail data 320 instead of the entire document data 310, may preserve information on the document data 310 based on which the QA set 330 is generated, while maintaining a reduced data size.

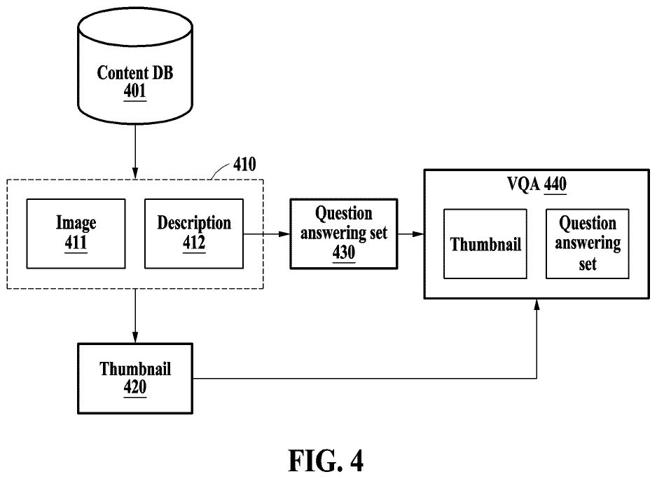

FIG. 4 is a diagram illustrating an example method of generating VQA data based on a pair of image data and description data according to one or more embodiments.

As described above, content data may include image data 411 and description data 412 associated with the image data 411. Hereinafter, the combination of the image data 411 and the description data 412 may be referred to as an image-description set 410. The image-description set 410 may be obtained from a content database (DB) 401. The content DB 401 may correspond to the content DB 301 described above with reference to FIG. 3.

Thumbnail data 420 corresponding to the image-description set 410 may be generated. For example, the thumbnail data 420 may include image data by juxtaposing the image data 411 and the description data 412. For example, the thumbnail data 420 may include image data generated by arranging the image data 411 and the description data 412 in a predetermined template.

Based on the description data 412 of the image-description set 410, a QA set 430 corresponding to the image-description set 410 may be obtained. In this case, only the description data 412, and not the image data 411 itself, may be used to generate the QA set 430.

A pair comprising the thumbnail data 420 and the QA set 430 may be generated as VQA data 440 corresponding to the image-description set 410. The thumbnail data 420 may include data that indicates or identifies the image-description set 410 where the QA set 430 is generated. The VQA data 440, by including the thumbnail data 420 forming a pair with the QA set 430, may preserve information on the image-description set 410 based on which the QA set 430 is generated. The VQA data 440, by including the thumbnail data 420 corresponding to the image-description set 410 instead of including the whole image-description set 410, may preserve the information on the image-description set 410 while maintaining a reduced data size.

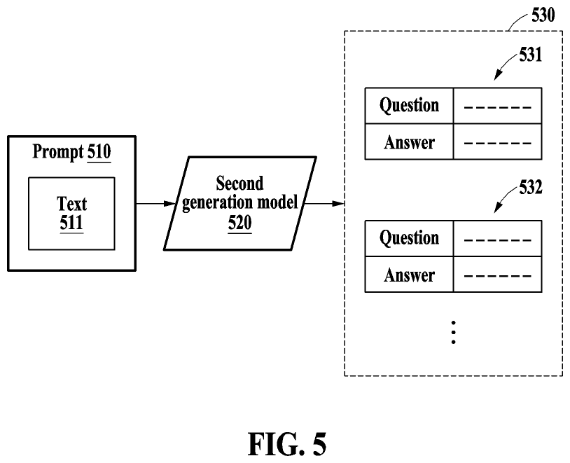

FIG. 5 is a diagram illustrating an example operation of generating a QA set based on a second generative model according to one or more embodiments.

Referring to FIG. 5, a QA set may be data generated by a second generative model 520 based on a prompt 510.

The prompt 510 applied to the second generative model 520 may be generated based on text data 511 extracted from content data. For example, the prompt 510 may include the extracted text data 511. For example, the prompt 510 may include data requesting to generate a question about the extracted text data 511 and an answer to the question from the second generative model 520. For example, the prompt 510 may include guideline information for data generation of the second generative model 520, such as the question type (e.g., subjective or multiple-choice), the tone of the question, or a specific question structure.

A QA set 530 may be generated by the second generative model 530 in response to the prompt 510. The QA set 530 may include one or more pieces of QA data, such as a first QA data 531 and a second QA data 532.

A question and an answer included in the first QA data 531 may be different from a question and an answer included in the second QA data 532. For example, the first QA data 531 and the second QA data 532 may be generated based on different sections of the content data. For example, the first QA data 531 may be related to a first section of the content data, while the second QA data 532 may be related to a second section of the content data. For example, the first QA data 531 may be data generated from content related to a first image included in the content data and the second QA data 532 may be data generated from content related to a second image included in the content data.

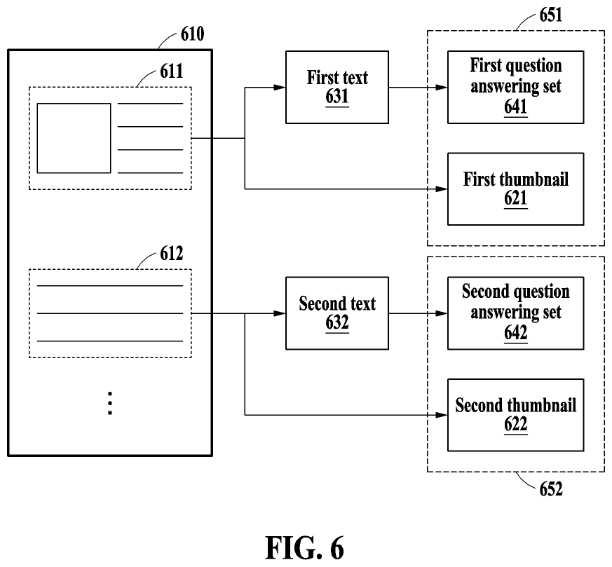

FIG. 6 is a diagram illustrating an example method of generating VQA data for each section of content data according to one or more embodiments.

Referring to FIG. 6, content data 610 may be divided into one or more sections. For example, the content data 610 may be divided into a first section 611 and a second section 612. The first section 611 may correspond to a part of the content data 610 and the second section 612 may correspond to another part of the content data 610. The first section 611 and the second section 612 may be contiguous, overlapping, or non-overlapping portions of the content data 610.

For example, sections of the content data 610 may be determined based on the format and/or content of the content data 610. For example, sections may be divided by page, table of contents, or image-based units.

When the sections of the content data 610 are divided into page units, the first section 611 may correspond to a first page of the content data 610 and the second section 612 may correspond to a second page of the content data 610.

When the sections of the content data 610 are divided into table-of-contents units, the first section 611 may correspond to a first table of contents of the content data 610 and the second section 612 may correspond to a second table of contents of the content data 610.

When the sections of the content data 610 are divided into image units, the first section 612 may correspond to a region including a first image and text data that describes the first image included in the content data 610 and the second section 612 may correspond to a region including a second image and text data that describes the second image included in the content data 610.

According to one or more embodiments, thumbnail data of the content data 610 may be generated for each section. First thumbnail data 621 may correspond to the first section 611, and second thumbnail data 622 may correspond to the second section 612.

According to one or more embodiments, a QA set of the content data 610 may be obtained from each section. Based on first text data 631 extracted from the first section 611, a first QA set 641 may be obtained. Based on second text data 632 extracted from the second section 612, a second QA set 642 may be obtained.

According to one or more embodiments, VQA data of the content data 610 may be generated for each section. The VQA data of the content data 610 may include first VQA data 651 including a pair of the first thumbnail data 621 and the first QA set 641 corresponding to the first section 611. The VQA data of the content data 610 may include second VQA data 652 including a pair of the second thumbnail data 622 and the second QA set 642 corresponding to the second section 612.

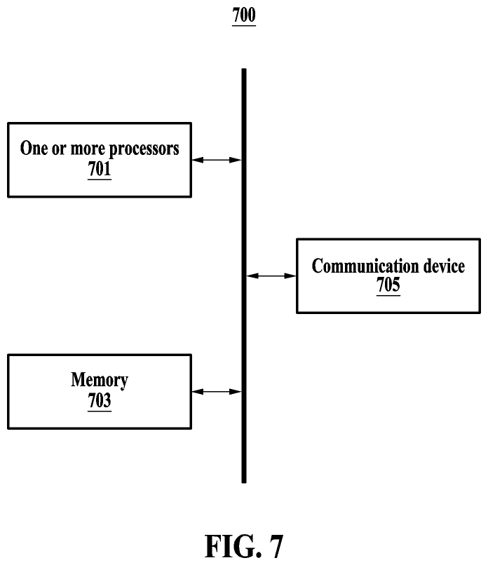

FIG. 7 is a diagram illustrating an example configuration of an electronic device according to one or more embodiments.

Referring to FIG. 7, an electronic device 700 may include one or more processors 701, a memory 703, and a communication device 705. The electronic device 700 may be configured to perform methods of generating VQA data described above with reference to FIGS. 1 through 6.

The one or more processors 701 may perform one or more operations of generating VQA data described above with reference to FIGS. 1 through 6. For example, the one or more processors 701 may perform operations such as generating thumbnail data corresponding to content data, obtaining a QA set generated based on text data extracted from the content data, and generating VQA data including a pair of the thumbnail data and the QA set.

The memory 703, which may be volatile or non-volatile, may store data associated with generating VQA data, including content data, thumbnail data, QA sets, or generated VQA data. The memory 703 may serve as a content database.

The communication device 705 may provide a function for the electronic device 700 to communicate with other electronic devices or other servers through a network. In other words, the electronic device 700 may be connected to an external device (e.g., a terminal, a server, or a network) via the communication device 705 and exchange data.

According to one or more embodiments, the memory 703 may not be a component of the electronic device 700 but may be included in the external device accessible from the electronic device 700. In this case, the electronic device may receive data stored in the memory 703 included in the external device and may transmit data to be stored in the memory 703 via the communication device 705.

The memory 703 may store programs implementing the methods of generating VQA data described above with reference to FIGS. 1 through 6. The one or more processors 701 may execute the programs stored in the memory 703 to control operations of the electronic device 700. Code of the programs executed by the one or more processors 701 may be stored in the memory 703.

The memory 703 may store instruction(s) that, when executed by one or more processors 701, may cause the one or more processors 701 to generate thumbnail data corresponding to content data, obtain a QA set generated based on text data extracted from the content data, and generate VQA data including a pair of the thumbnail data and the QA set.

The electronic device 700 may further include components not shown in the drawings. For example, the electronic device 700 may further include an input/output interface including an input device and an output device as the means of interfacing with the communication device 705. For another example, the electronic device 700 may further include other components, such as transceivers, various sensors, and databases.

The electronic devices, processors, memory, storage devices, electronic device 700, processors 701, memory 703, communication device 705, and other apparatuses, devices, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
generating thumbnail data corresponding to content data;
obtaining a question answering (QA) set generated based on text data extracted from the content data; and
generating visual question answering (VQA) data comprising a pair of the thumbnail data and the QA set.

2. The method of claim 1, further comprising training a first generative model using the VQA data.

3. The method of claim 1, wherein the obtaining of the QA set comprises:
separating the content data into image-type data and text-type data; and
obtaining a QA set generated based on the text-type data.

4. The method of claim 1, wherein the obtaining of the QA set comprises:
separating the content data into image-type data and text-type data; and
applying the text-type data to a second generative model to generate the QA set.

5. The method of claim 4, wherein the applying of the text-type data to the second generative model comprises:
generating a prompt based on the text-type data; and
generating the QA set in response to the prompt from the second generative model.

6. The method of claim 1, wherein the content data comprises document data including at least one piece of image data and associated text data.

7. The method of claim 1, wherein the content data comprises image data and associated description data.

8. The method of claim 1, wherein the generating of the thumbnail data comprises:
dividing the content data into a plurality of sections; and
generating thumbnail data for each section of the content data.

9. The method of claim 8, wherein the obtaining of the QA set comprises:
extracting text data from each section; and
obtaining a QA set for each section based on the extracted text data.

10. The method of claim 9, wherein the generating of the VQA data comprises:
generating one piece of VQA data for each section, the one piece of VOA data including a pair of thumbnail data and the QA set corresponding to that each section.

11. The method of claim 1, wherein the generating of the thumbnail data comprises:
arranging image data and corresponding text data in a predetermined template.

12. A non-transitory computer-readable storage medium, storing a computer program that operates in combination with hardware, configured to:
generate thumbnail data corresponding to content data,
obtain a question answering (QA) set generated based on text data extracted from the content data, and
generate visual QA (VQA) data comprising a pair of the thumbnail data and the QA set.

13. An electronic device comprising:
one or more processors configured to:
generate thumbnail data corresponding to content data,
obtain a question answering (QA) set generated based on text data extracted from the content data, and
generate visual QA (VQA) data comprising a pair of the thumbnail data and the QA set.

14. The electronic device of claim 13, wherein the one or more processors are further configured to train a first generative model using the VQA data.

15. The electronic device of claim 13, wherein the one or more processors are further configured to:
separate the content data into image-type data and text-type data; and
obtaining the QA set generated based on the text-type data.

16. The electronic device of claim 13, wherein the one or more processors are further configured to:
separate the content data into image-type data and text-type data; and
apply the text-type data to a second generative model to generate the QA set.

17. The electronic device of claim 16, wherein the one or more processors are further configured to:
generate a prompt based on the text-type data; and
generate the QA set in response to the prompt from the second generative model.

18. The electronic device of claim 13, wherein the content data comprises document data including at least one piece of image data and associated text data.

19. The electronic device of claim 13, wherein the content data comprises image data and associated description data.

20. The electronic device of claim 13, wherein the one or more processors are further configured to:
divide the content data into a plurality of sections; and
generate thumbnail data for each section of the content data.
